(19) United States
(12) Patent Application Publication
(10) Pub. No.: US 2016/0162907 A1
(43) Pub. Date: Jun. 9, 2016

(54) SYSTEM AND METHOD FOR IDENTIFYING AND AUTHENTICATING A TAG

(71) Applicant: NISS GROUP SA, Nyon (CH)

(72) Inventors: Hua LIU, Carlingford, New South Wales (AU); Christophe PACHE, Lausanne (CH); Tom MCGREGOR, West Ryde, New South Wales (AU); Sayee GANJEKAR, Dundas Valley, New South Wales (AU)

(21) Appl. No.: 14/906,094

(22) PCT Filed: Jul. 18, 2014
(86) PCT No.: PCT/IB2014/063209

§ 371 Date: Jan. 19, 2016

Related U.S. Application Data
(63) Continuation of application No. PCT/IB2013/001629, filed on Jul. 19, 2013.

(30) Foreign Application Priority Data
Jul. 19, 2013 (IB) PCT/IB2013/001629

(51) Int. Cl. G06Q 30/00; G06K 7/14; G06K 7/10

(52) U.S. Cl. CPC G06Q 30/0185; G06K 7/10722; G06K 7/1408

(57) ABSTRACT

The invention relates to a system (100) and method for identifying and authenticating a tag defined by at least a spatial pattern and the spectral signature of luminescent particles. The system comprises a reading module (110), a processing module (120) and a database (130) containing the stored tag identities. The spatial pattern and spectral signature are acquired by an imaging unit (111) and a spectral unit (112) respectively in a sequential manner, the acquisition being synchronized with different excitation light pulses. The validation of the tag comprises the use of background and signal acquired by both the imaging unit (111) and the spectral unit (112).

### FIELD OF THE INVENTION

The invention relates to a system and a method for identifying and authenticating a tag applied on a variety of items as means of identification and authentication.

### BACKGROUND OF THE INVENTION

The positive identification of products, their tracking and authentication are already applied and used in many fields of the industry and are continuously developed and improved. The marking of products for identification, authentication and tracking purposes is increasingly applied in many fields of the industry. Security markings of various degrees of complexity exist and are applied on items and products helping to answer the question whether a given product is genuine or counterfeit. Counterfeiting indeed is a worldwide problem resulting in huge economic losses and negatively impacting consumers and producers. To counteract this problem, anti-counterfeiting technology is constantly being developed including new security markings and adapted readers. Such security marking may have both spatial and spectral coding components.

WO2010012046 generally describes a code carrier having fluorescent markings. It mentions a reader engineered for reading a fluorescent code carrier in which the recorded information is encoded into visual features of a coded visual marking. This reader apparatus may include a combination of two reading apparatuses, one that reads the fluorescent properties of the fluorescent material in the coded fluorescent marking and the other which reads the visual features of the coded fluorescent marking. In this document, the fluorescent signal is read and decoded first and the visual shape properties are subsequently decoded.

U.S. Pat. No. 7,441,704 describes a system and method for identifying a spatial code having one or multi-dimensional pattern applied to an object, where the spatial code includes a plurality of security tags or compositions having one or more characteristic emission spectral signatures. The system uses beam source to illuminate the code, a spectrometer to analyse its signature and a camera to identify the code. It also comprises a beam splitter for splitting the emitted light from the code to both an image detector and an optical spectrometer which induces a simultaneous acquisition of the information/data.

U.S. Pat. No. 7,938,331 describes a reader to authenticate a tag/marking/code (an automatic identification symbol e.g. a barcode) applied to an item and having specific spectral emission signatures. The specific spectral signature of the tag/code is applied in addition elsewhere on the item. If both spectral signatures are recognized and both match, the product validation is performed without accessing an external database. The system uses an illumination light to excite the fluorescent tag, a spectrometer to analyse its signature and a camera to identify the code.

All the above-mentioned systems use the spectral properties of a tag having a code carrier structure. The use of a spectrometer in addition to a camera offers the highest accuracy and thus, guarantees a high level security. However, even if certain systems make use of these two detectors, they do not allow a fully independent setting of their acquisition parameters such as integration time and excitation light intensity. Moreover, none of the above-mentioned methods fully benefits from the information available in the camera images as they do not analyse their spectral characteristics prior to analysing the information recorded by the spectrometer.

Therefore, it is desirable to provide further systems and methods for identifying and authenticating security codes/tags that have unique spatial and spectral properties via optimized identification and authentication means, such means allowing a fast and reliable authentication process.

### SUMMARY OF THE INVENTION

Disclosed herein is a system for identifying and authenticating a tag applied to an object, wherein the tag is defined by at least one luminescent spatial pattern and one spectral signature of optically active nanoparticles, namely luminescent nanoparticles, contained in said tag and defining said spatial pattern. The system comprises:
a reading module to acquire the tag information, said reading module comprising: a lighting unit comprising a light source driven in a pulse-mode, said light source being adapted to illuminate the tag with excitation light so as to excite the luminescent particles of the tag, thus resulting in the emission of the luminescent spatial pattern by the tag; an imaging unit adapted to record an image of said spatial pattern; a spectral unit adapted to record the spectrum of said spectral signature; a timing control unit adapted to synchronize the actions of the other units of the reading module; and
a processing module both in communication with the reading module and with a database containing the spatial patterns and spectral signatures of predetermined tags, said processing module comprising: a decoding unit adapted to decode the image recorded by the imaging unit, provide a serial number corresponding to said image and compare said serial number with the corresponding serial numbers of the predetermined tags so as to identify the tag; a validation unit adapted to compare the spectrum recorded by the spectral unit with the spectra of the predetermined tags so as to authenticate the tag, and a read-out unit to disclose information about the tag once authenticated.

The imaging unit and the spectral unit may advantageously record their respective signals in a sequential manner, their acquisition being synchronized with different excitation light pulses.

In an embodiment, a first and a second excitation light pulses are used.

In an embodiment, the acquisition of the imaging unit is synchronized with the first excitation light pulse and the acquisition of the spectral unit is synchronized with the second pulse.

In an embodiment, the imaging unit records a signal image and a background image and the spectral unit records a signal spectrum and background spectrum.

In an embodiment, the decoding unit performs the identification of the tag using the image resulting from the subtraction of the background image from the signal image and the spectral unit performs the validation of the tag using the spectrum resulting from the subtraction of the background spectrum from the signal spectrum.

In an embodiment, the system further comprises a global positioning unit and a localization unit.

Also disclosed herein is a method for identifying and authenticating a tag applied to an object, wherein the tag is defined by at least one luminescent spatial pattern and one spectral signature of luminescent particles contained in said tag and defining said spatial pattern, comprising the steps of : illuminating the tag with excitation light emitted by a light source driven in a pulse-mode so as to excite the luminescent particles of the tag, thus resulting in the emission of the luminescent spatial pattern by the tag; recording with an imaging unit an image of said spatial pattern; recording with a spectral unit a spectrum of said spectral signature; decoding with a decoding unit said image so as to identify the tag; and validating with a validation unit said spectrum so as to authenticate the tag.

The imaging unit and the spectral unit may advantageously record their respective signals in a sequential manner, their acquisition being synchronized with different excitation light pulses.

In an embodiment, a first and a second excitation light pulses are used.

In an embodiment, the acquisition of the imaging unit is synchronized with the first excitation light pulse and the acquisition of the spectral unit is synchronized with the second excitation light pulse.

In an embodiment, the imaging unit records a signal image and a background image and the spectral unit records a signal spectrum and background spectrum.

In an embodiment, the decoding unit performs the identification of the tag using the image resulting from the subtraction of the background image from the signal image and the spectral unit performs the validation of the tag using the spectrum resulting from the subtraction of the background spectrum from the signal spectrum.

In an embodiment, the method further comprises a step of determining the exact position of the tag.

Also disclosed herein is a method for identifying and authenticating a tag applied to an object, wherein the tag is defined by at least one luminescent spatial pattern and the one spectral signature of luminescent particles contained in said tag and defining said spatial pattern, comprising the steps of: illuminating the tag with an excitation light emitted by a light source driven in a pulse-mode so as to excite the particles of the tag, thus resulting in the emission of the luminescent spatial pattern by the tag; recording with an imaging unit a signal image and a background image of said spatial pattern; subtracting the background image from the signal image so as to determine an image of said spatial pattern; recording with a spectral unit a signal spectrum and a background spectrum, of said spectral signature; subtracting the background spectrum from the signal spectrum so as to determine a spectrum of said spectral signature; decoding with a decoding unit said images, so as to identify the tag, and validating with a validation unit said image and the spectrum, by decomposing said image into different colour components and comparing the intensity ratios between said colour components with the information stored in the database, and comparing said spectrum to the signal spectrum to the spectra stored in the database.

In an embodiment, the decoding unit performs a pre-validation step consisting in checking the presence of the spatial pattern on the image resulting from the subtraction of the background image from the signal image.

In an embodiment, the validation unit performs a first validation level using the information recorded by the imaging unit by decomposing the image of the tag into three colour components and analysing their ratios.

In an embodiment, the validation unit performs a second and third validation levels using the information recorded by the spectral unit by analysing the peak intensities at certain wavelengths and the ratios between these values.

In an embodiment, the validation unit performs a further step of calculating the fluorescence lifetime of the luminescent particles.

Also disclosed herein is a tag comprising a plurality of dots of luminescent material defining a code comprising a plurality of values greater than binary values, by the use of different types of luminescent materials emitting different spectra. The tag applied to an object is defined by at least one luminescent spatial pattern and one spectral signature of luminescent particles contained in said tag and defining said spatial pattern, the tag comprising a plurality of dots. Each dot comprises one or more luminescent materials, wherein one or more dots comprise at least one luminescent material different from at least one luminescent material in one or more other dots, the different luminescent materials emitting different spectra such that the tag defines a code comprising a plurality of values greater than binary values.

Further advantageous aspects and features of the invention will be apparent from the detailed description and figures.

### BRIEF DESCRIPTION OF THE DRAWINGS

Features and advantages of the present invention will become better understood with regard to the following detailed description, claims and drawings where:

FIG. 1 illustrates a tag and a reading module of a system according to a first embodiment of the present invention;

FIG. 2 illustrates an example of an object marked with several types of luminescent particles embedded into the object according to embodiments of the invention;

FIG. 3 illustrates examples of spatial patterns of tags that may be read by a system according to embodiments of the invention;

FIG. 4 represents a block diagram illustrating a system according to a first embodiment of the present invention;

FIG. 5 is a time-diagram illustrating a synchronization pattern of a reading module used in a system according to embodiments of the present invention;

FIG. 6 depicts a flow-chart of an exemplary method performed by the system of FIG. 1;

FIG. 7 represents a block diagram illustrating a system according to a second embodiment of the present invention;

FIG. 8 is a graph illustrating an example of a spectrum of a tag acquired with a reading module of a system, after background subtraction, according to an embodiment of the invention;

### DETAILED DESCRIPTION OF THE INVENTION

The invention relates to a system and method enabling the identification, authentication, tracing and the localization of tagged products with high-level security from any distance. The system comprises a reading module, a processing module and a database containing the stored tag identities. The identity of the tag is defined by two distinct signatures: a luminescent spatial pattern and a unique optical spectral signature. The tag contains or forms a spatial pattern, and comprises luminescent material, in particular fluorescent particles. By detecting the two signatures with the reading module, the information is processed and the tag identity validated against the information already contained in the database allowing thereby the authentication of the product. This overall procedure enables the identification and authentication of the product. Additionally, the system enables to reveal the accurate position of the tag through a combination of optical measurement and global positioning.

1. Definitions

The terms below have the following meaning unless indicated otherwise in the specification.

A “tag” is an identity marking having two distinct signatures: a luminescent spatial pattern and a unique optical spectral signature. The tag may be affixed on a variety of products and items that need to be authenticated. Products bearing a tag are referred to as “tagged” or “marked” products

A “spatial pattern” or “luminescent spatial pattern”, is a specific one-two-or three-dimensional structure that can be identified and related to a unique serial number. The structure may take any shape and/or form a one-two-or three-dimensional code. For example, it could comprise multiple layers, offering a three-dimensional spatial extent.

The “spectral signature” refers to the distribution of the luminescent light emitted by the tag along the wavelength axis. It can be measured with various instruments such as e.g. a spectrometer or a digital camera. When measured with a spectrometer, this signature is referred to as a spectrum or spectra. If recorded by a colour camera, the resulting colour of the image will be defined by said spectral signature.

“Particles” are metallic crystals or powders with a diameter typically comprised in the micrometer, sub-micrometer or nanometer range. When illuminated with excitation light in the wavelength range from 800 to 2000 nm (typically 980 nm) these particles emit light with a specific spectral signature in a range from 450 to 900 nm. Each type of particle is characterized by a specific and unique spectral signature, depending on several parameters such as its chemical composition, size or shape. A mix of several types of particles will have a unique spectral signature, depending on the concentration of each type of particles contained into the mixed solution/powder.

“Luminescent material” is a material that up-converts or down-converts an excitation light, such as luminescent particles embedded or held together in a binder or matrix material, for instance an epoxy or other polymeric material.

An “excitation light” is an electromagnetic energy in a first predefined wavelength or predefined range of wavelengths capable of being upconverted, respectively downconverted by luminescent material to produce light at a second predefined wavelength or predefined range of wavelengths, whereby the excitation light may be out of the visible range, for instance infrared or ultraviolet light, and the produced light in the human eye visible range.

“Identification”, “identify” as used herein refers to the step of decoding the first signature of the tag, in particular the spatial pattern, on the basis of a match against the data stored in a database. Each spatial pattern relates to a single serial number.

“Decoding” means reading the serial number coded into the spatial pattern and verifying its integrity. This process is uniquely based onto the spatial pattern signature of the tag. A successful decoding of a tag enables its “identification”.

“Authentication”, “authenticate” as used herein refers to the step of validating the second signature of the tag, in particular the spectral signature. This step comes after the identification step and thus, proves that a product is genuine.

“Validation”, “validate” means analysing the spectral signature of the tag, for instance via the information recorded by both a colour camera and a spectrometer. This process is performed after the decoding process. A successful validation of a tag enables its “authentication”.

2. Tag

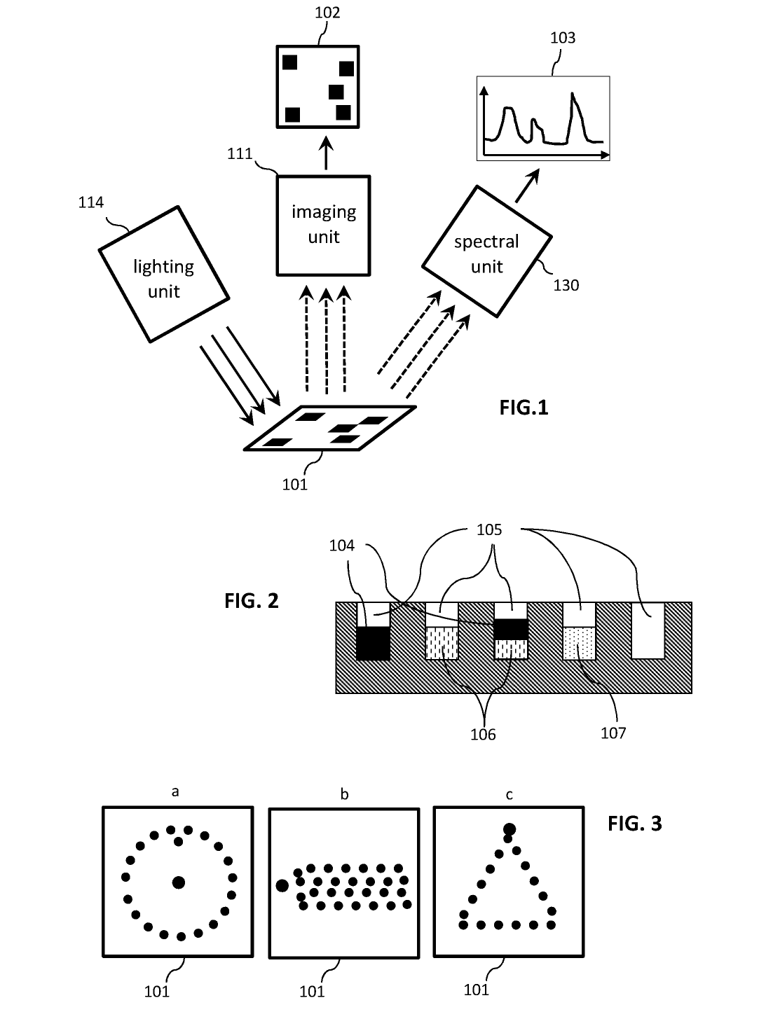

This section describes a tag that can be identified and authenticated with the system according to the invention. The identity of the tag is defined by two distinct signatures: a luminescent spatial pattern and a unique spectral signature specific to the luminescent particles contained into the spatial pattern. The tag contains or forms a spatial pattern representing some type of informatics code. It comprises luminescent material. As illustrated in FIG. 1, when excited with infrared (IR) light (800-2000 nm, typically 980 nm) emitted by a lighting unit 114, the luminescent particles present in the tag 101 emit light at shorter wavelengths (450-900 nm). This so-called optical upconversion is an anti-Stokes fluorescent process and results in a specific spectral signature for the emitted light. The excitation light may also be in the ultraviolet range (280-400 nm, typically 375 nm), which results in the emission of visible light by the luminescent particles due to a downconversion effect. The emitted light is collected by the reader instrument containing the reading module 110 of the system 100 through two distinctive channels: the imaging unit 111 and the spectral unit 112. The imaging unit 111 records an image (e.g., 102) of the luminescent spatial pattern when the excitation light is applied, while the spectral unit 111 records its detailed spectral distribution i.e. the spectrum (e.g. 103). The identity of a tag consists in both the spatial pattern and the spectral signature of luminescent particles embedded in the luminescent material.

The spatial pattern is a one- or multi-dimensional structure created by the characteristic distribution of the luminescent material in the tag. It arises due to the fact that luminescent light is emitted only in the pre-defined areas of the tag 101 containing the luminescent particles while the other areas of the tag remain inactive. In order to create the tag, particles may be introduced into a host material (such as a polymer) prior to its application to another material. The tag may be directly created onto the marked product or can form a full-assembly that is then attached or bonded to the marked product. It can be created onto (or attached to) any type of material.

When the spatial pattern consists of repetitive structures, a large number of codes is created by varying the contrast of each individual structure. Data matrix code made out of square structures is a typical two-dimensional example of such patterns.

Inorganic particles (e.g. Lanthanide doped fluorides) used in the material forming the tags are supplied in powder form and in order to fabricate the tag, they can be mixed with a polymer (e.g. epoxy) in liquid phase. The luminescent material may thus comprise luminescent particles embedded in a polymeric material that can be easily printed or otherwise deposited on the article to be tagged (marked). The material forming the tag may however be made in other ways and with other materials, per se known, as long as the tag material exhibits luminescent properties when excited with the chosen excitation light as described previously. The luminescent particles may for instance be directly fixed onto the marked product surface, using its surface as a host matrix.

Tags can be incorporated onto articles comprising several types of materials, such as leather, glass, metal, plastic or wood. In an embodiment, the spatial pattern may be created by depositing the luminescent material in a plurality of discrete dots or discrete islands. The discrete dots or islands in their simplest form may have a basic shape that is essentially circular, however they may have various other basic shapes, such as elliptical, square, rectangular, polygonal, triangular or any other regular or irregular shape. Discrete dots or islands of luminescent material in different basic shapes may be combined in a tag.

In an embodiment, a series of holes or recesses describing a spatial pattern are created onto the object to mark. A hole or recess may form or encompass a basic shape of the above mentioned dot or island. The holes or recesses forming the spatial pattern can be created directly onto the object by any engraving technique such as laser, etching, mechanical stamping or micro-machining. Then, the luminescent material is deposited into several of these recesses in order to define a specific spatial code identifying the object.

In an embodiment, the article to be tagged may be provided with a standard set of recesses or holes in a pattern that is common to the standard set on other articles, however the luminescent material may be deposited in only a subset of the standard set, or in any combination of recesses less than the complete set of recesses to form various spatial patterns. This allows reducing manufacturing costs associated to the formation of recesses or holes on the surface of the article to be tagged, whereby the printing or deposition of luminescent material in various specific positions can be easily configured.

Thereafter, a protective layer, for instance of a polymer material, may be placed on top of the luminescent material. The remaining holes or recesses that do not contain luminescent particles may also be filled with this protective layer material. The protective layer material can be of various types provided that it is not opaque to the range of wavelengths of the excitation light and the light emitted by the luminescent material, preferred materials including polymer materials.

FIG. 2 shows an example of an item directly marked with the proposed techniques, where the luminescent material is directly embedded into holes created in the item. The first hole is filled with a first type of luminescent material 104 (particles embedded in a host matrix) and covered with a protective layer 105. The second hole is filled with another type of luminescent material 106 and covered with the protective layer 105 while the third hole exemplifies the possibility to fill the hole with two different types of luminescent materials (104 and 106) arranged in layers, covered with the protective layer 105. The fourth hole is filled with a third type of luminescent material 107 while the fifth hole is filled only with the protective layer 105 and contains no luminescent particles.

As illustrated in FIG. 3, different code designs are represented by different spatial patterns of discrete dots having circular basic shapes, for instance having diameters in the range of 20-300 μm and a total area of about 1-40 mm². The dots may be arranged spatially to form different tag shapes and sizes, depending on the application. In this example, the luminescent material dots define a binary code, interpretable by the reading system. The dots of the tag thus define a specific pattern that can form a unique code.

The code may comprise a plurality of values greater than binary values. By the use of different luminescent materials emitting different spectra to form different dots, each dot may represent more than two possible values, the number of values depending on the number of different identifiable spectra that are represented. Different luminescent materials may be produced by using different luminescent particles, or by different mixes of different luminescent particles. The density of luminescent particles in a luminescent material may also be varied, in order to vary the read-out intensity, which may provide a supplementary value for the code.

3. System and Method

This section describes a system 100 able to identify, authenticate and localize a tag. The identification and authentication are achieved by decoding the spatial pattern and validating the spectral signature contained into the tag. The localization of the reader instrument is performed by the use of a global positioning system. In combination with the optical localization provided by the system, the precise position of the tag is identified and recorded into the database 130.

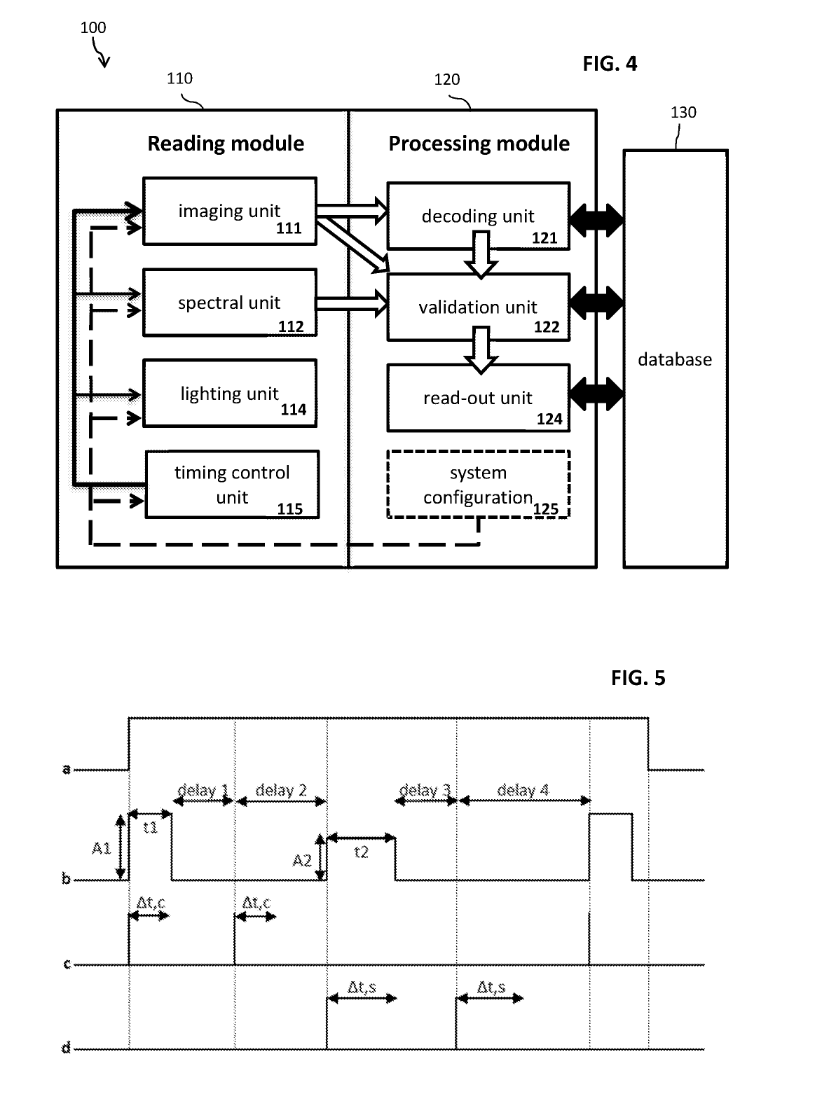

The system 100 comprises a reading module 110 in communication with a processing module 120, which in turns communicates with the database 130 during decoding and validation processes as well as during the read-out. FIG. 4 discloses a block diagram of the whole system and the interactions between the different units.

The system 100 is preferably constructed as part of a hand-held device. However, for applications where it is convenient to scan tags at fixed positions, the system can be designed and operated at a fixed unit. The reader instrument provides a user interface, enabling the user to control and communicate with the system 100. The reader instrument is driven by a software, embedded into a processing apparatus, such as a computer.

The reading module 110, may be comprises the following units:

A lighting unit 114 that provides a homogeneous illumination of the tag with at least one light source, at a wavelength corresponding to the excitation wavelength of the luminescent particles contained into the tag, typically in the infrared spectrum when using the upconversion effect. This light source is driven in a pulse-mode, triggered by the timing control unit 115. To create the illumination pattern, the output of the light source is redirected towards the tag through an optical system (comprising elements such as lenses, mirrors and optical fibres). For safety reasons, a lighting indicator may advantageously be placed externally onto the reader instrument, so as to indicate to the user if the light source emits light or not. Such a lighting indicator may be controlled by the timing control unit 115. In another embodiment, the lighting unit 114 contains at least one additional light source at any wavelength for the detection of other optical effects than upconversion that may be generated by the tag.

An imaging unit 111 that collects the image emitted by the tag 101 by the use of at least one sensor, such as a colour CMOS or CCD chip. In this unit, an optical filter discards the remaining excitation light. The sensor acquires and sends data to the processing module 121. The images correspond to visual representations of the spatial pattern.

The imaging unit 111 may record images whilst the excitation light is on or off. The image recorded when the excitation light is on corresponds to the “signal” image whereas the one recorded whilst the excitation light is off is referred to as the “background” image. The background image can be recorded prior or after recording the signal image.

A spectral unit 112 that collects the luminescent light emitted by the tag and redirects it towards a spectrometer, for example by the use of an optical fibre. An optical filter discards the remaining excitation light. The spectrometer may be made out of a diffraction grating, an imaging lens and a CCD line array. In another embodiment, the spectrometer uses other optical components to record the spectrum, such as a prism and/or a CMOS detector. The spectrometer records the spectrum and sends data to the processing module 121.

The spectral unit 112 may record the spectrum whilst the excitation light is on or off. The spectrum recorded when the excitation light is on corresponds to the “signal” spectrum whereas the one recorded whilst the excitation light is off is referred to as the “background” spectrum. The background spectrum can be recorded prior or after recording the signal spectrum.

As the tag may contain different types of luminescent particles at different locations, the spectral unit 112 may raster scan a small collection area over the tag and acquire each signal sequentially. This enables to authenticate the spectral signature of each dot (or island) independently. The scanning of the small collection area over the full field-of-view can be performed by the use of galvo-mirrors. Such a configuration may also require the use of several excitation light pulses and a synchronous scan of a smaller excitation area and collection area.

A timing control unit 115 controls the sequence of the reading process. This unit triggers light pulses of the lighting unit 114 and synchronizes the acquisition of the imaging 111 and the spectral units 112.

Each of these two units acquires data sequentially, synchronized on individual light pulses. The reading process can be continuously, automatically or manually enabled. In manual mode, a user operating the system presses on a physical trigger placed onto the reader instrument to enable the reading. While kept pushed, this trigger enables the repetitive output of light pulses, such as illustrated in FIG. 5. In FIG. 5, from top to bottom, the lines represent (a) the “trigger” (system enabled), (b) the light pulses of the lighting unit 114, (c) the camera trigger of the imaging unit 111 and (d), the spectrometer trigger of the spectral unit 112. A1 and A2 represent the amplitudes of the light pulses (optical power); t1 and t2, the durations of pulse 1 and pulse 2 respectively. Delay 1-4 represent the times after which a trigger pulse is emitted onto the imaging and spectral units in order to start the acquisitions of the signal image/spectrum and background image/spectrum on the respective trigger lines (camera and spectrometer triggers). The integration times of the camera and the spectrometer are represented by Δt,c and Δt,s respectively. The integration time is the period over which the sensor is exposed to light. In this example, the enabling line allows the generation of one full cycle of two pulses and stops after the first light pulse of the second cycle.

The timing control unit 115 emits 2 trigger events per trigger line. The first line (c), connected to the camera, provides a trigger at the beginning of pulse 1 and after delay 1, while the second line (d), connected to the spectrometer, indicates the beginning of pulse 2 and also the end of delay 3. Each trigger on the camera and the spectrometer lines enables an acquisition of data. The use of sequential pulses, preferably two, for the camera (pulse 1) and the spectrometer (pulse 2) allows setting the amplitude and the duration of each pulse independently. As the imaging unit 111 and the spectral unit 112 have completely different sensitivities, the sequential acquisition allows maximizing the signal-to-noise ratio for each component independently. Another advantage of this synchronization pattern lies in the fact that the processing of the data acquired by the imaging unit 111 on the first pulse, can start while the spectral unit 114 is still acquiring. This enables a faster authentication process. In addition, this synchronization pattern allows background subtraction. Indeed, by recording a background image and a spectrum while the light source is off (on the trigger event after delays 1 and 3 respectively), it allows subtracting the background image/spectrum acquired in the “dark” from the signal image/spectrum acquired while the excitation light is on. This procedure drastically enhances the signal of interest as it discards the effect of the parasitic ambient light.

Referring to FIG. 5, a specific example of a reading process sequence controlled by the timing unit 115 is illustrated. In order to start an acquisition cycle, the user presses for instance a physical trigger placed onto the reader. While kept pushed, this trigger enables the output of laser pulses. The laser driver board contains 2 trigger lines directly connected to the camera and the spectrometer. The synchronization pattern is defined in the configuration file by the use of the following parameters:
A1 and A2: amplitudes of the laser pulses, defined in terms of the current driving the laser diode, which is proportional to the optical power
t1 and t2: durations of pulse 1 and pulse 2
delay 1 , 2, 3 and 4: after delay 1, the laser board emits a trigger pulse onto the camera trigger line (background acquisition), the 2nd delay allows to set the time before the second pulse and the 3rd delay sets the waiting time before the spectrometer background acquisition. The delay 4 defines the waiting time prior to the next cycle.
Δt,c and Δt,s represent the integration time of the camera and the spectrometer respectively. The integration time is the period over which the sensor is exposed to light. These two values are logically set equal to t1 and t2.

In this specific example, the laser driver board emits 2 trigger events per trigger line. The first line, connected to the camera, provides a trigger at the beginning of pulse 1 and after delay 1, while the second line, connected to the spectrometer, indicates the beginning of pulse 2 and also the end of delay 3. Each trigger on the camera and the spectrometer lines enables an acquisition of data.

The use of two sequential pulses for the camera and the spectrometer allows setting the amplitude and the duration of each pulse independently. As the camera and the spectrometer may have completely different sensitivities, it enables optimization of the signal-to-noise ratio for each component.

Another advantage of this synchronization pattern lies in the background subtraction. Indeed, by recording data for both the camera and the spectrometer while the laser is off (on the trigger event after delays 1 and 3 respectively), it allows us to calculate a differential image/spectrum where we subtract the background image/spectrum acquired in the “dark” from the signal image/spectrum acquired when the excitation light is on. This procedure drastically enhances the signal of interest as it discards the effect of the parasitic ambient light.

The reader may comprise a status indicator, for instance red and green LEDs. The red LED, for instance placed on top of the reader, indicates to the user when the laser is ON for safety reasons. It is then synchronized with the enable line. The green LED may be turned ON for several seconds after a successful tag authentication. This event may be triggered by software and relayed by the timing control unit to the LED.

The information acquired through the reading module 110 is delivered to the processing module 120 that may comprise the following units:

A decoding unit 121 that allows identifying the tag using the images (background and signal) sent by the imaging unit 111. The spatial pattern is decoded in order to get the tag serial number. The decoding may be performed by various known methods such as barcode or Quick Response (QR) code reading (see e.g. EP0672994 for QR code decoding). The decoding may also be performed by simple pattern recognition where each tag serial number is uniquely related to a specific pattern. A communication with the database 130 is then established in order to verify the existence of this number in the database 130. If this number already exists in the database 130, the tag 101 is considered as identified.

A validation unit 122 that allows authenticating the tag using the spectra (background and signal) sent by the spectral unit 112. The spectrum is compared to the predetermined spectra of the “authentic” tags stored in the database 130. Mathematical criteria are used to perform an accurate comparison and thus conclude whether it is genuine or not.

The validation unit 122 may in addition use the images (background and signal) acquired by the imaging unit 111. In this case it proceeds to a validation process in two distinctive steps: the analysis of the image colours followed by the above-mentioned analysis of the spectrum. In the first step, the analysis of the image colours after background subtraction consists in decomposing the image of the spatial pattern into three colour channels: red, green and blue. This decomposition may be performed by known techniques such as the one described in U.S. Pat. No. 8,313,030. Indeed, with a colour camera, each pixel of an image is coded over three values corresponding to red, green and blue components of the light. While reading a tag, the intensity ratios between these three components are specific to the type of particles contained into the tag. Thus, it allows rapidly validating or invalidating the tag. In the second step, the spectrum acquired by the spectral unit 112 is compared to the predetermined spectra of the “authentic” tags stored in the database 130. This second validation procedure offers a greater precision than the first one and is therefore necessary to ensure high security level. However, the calculations required are time-consuming. Hence, this two-step method avoids initiating relatively long computations for authenticating a spectral signature which obviously does not have a correct match in the database 130 as it will be discarded by the first step. Moreover, this approach provides more robustness and security to the authentication.

A read-out unit 124 that discloses information about the tag once authenticated. This unit may be used as an interface by a user to record information about the local position and state of the product into the database 130. The user may also consult the database 130 to get further information about the product.

A system configuration 125 unit that loads configuration files from the processing module 120 to the reading module 110. This configuration sets all the parameters that are necessary for the different units of the reading module 110, such as for example the integration times of the different sensors or the duration and amplitudes of the lighting unit 114 light pulses. These settings are loaded prior to any tag reading.

A database 130 that contains predetermined spatial patterns and spectral signatures enabling the identification and authentication of each tag. It may contain a variety of information about marked products (e.g. description, picture, location), recorded by users. The user may also store current information about the marked products (e.g. location, state of the product). The database can be partly or fully stored into a remote electronic device. It can only be accessed by reader instruments that were formerly authorized.

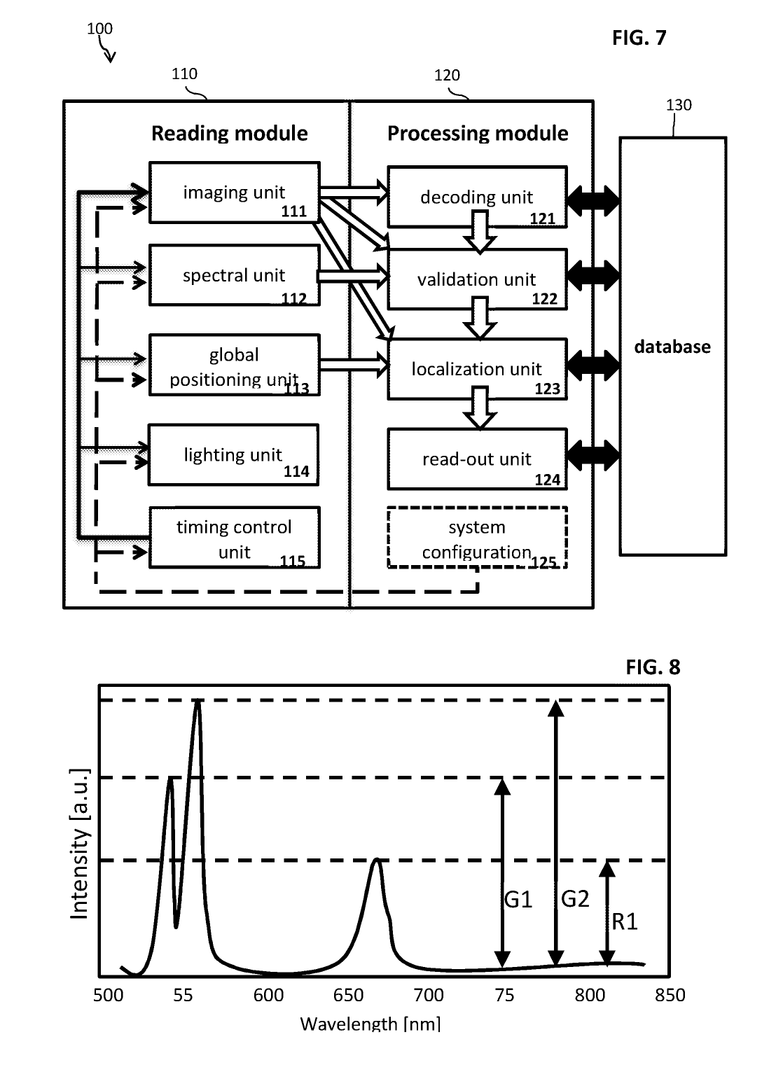

In a preferred embodiment, as illustrated in FIG. 7, the system 100 comprises two further units: a global positioning unit 113 in the reading module 110 and a localization unit 123 in the processing module. The global positioning unit 113 communicates with the localization unit 123 and the imaging unit 111 communicates with the decoding unit 121, validation unit 122 and localization unit 123.

The global positioning unit 113 gets an access to the local position of the reader instrument (for example by the use of a GPS or A-GPS module) and, depending on the application, it also monitors the direction in which the reader is pointing by the use of an electronic compass and inclinometer. After each successful validation, this information is sent to the processing module.

The localization unit 123 determines the exact global position of the tag. This position is calculated in three steps based on the information sent by the imaging 111 and the global positioning units 113. First, the distance between the reader instrument and the tag is optically measured based on the imaging unit 111 information. Second, the relative position of the tag in reference to the reader instrument is calculated by using the distance and the direction in which the reader instrument is pointing. Third, the relative position of the tag is added to the global position of the reader. The optical localization allows higher accuracy in determining the position of the tag in comparison to standard methods, such as radio systems. The optical distance measurement can be based on several techniques, depending on the working distance of the reader (distance between the reader and the tag). For distances up to several meters, either the distance is defined by the optical design (with fixed focal lenses) or it is be calculated by measuring the position of an auto-focussing lens. For longer distances, the distance is calculated by measuring the time of flight (time for the light to travel from the reader to the tag and return) or similarly, by phase shift methods. To implement such techniques, the imaging unit 111 may contain an additional dedicated sensor, such as a photodiode. This step may use a different timing scheme with a time modulation of the excitation light intensity.

The identification and authentication of the tag 101 is achieved by decoding and validating the spatial pattern and spectral signature contained into the tag using the system 100.

The decoding process starts as soon as two images sent by the camera are received. The first image corresponds to the signal and the second one to the background. The decoding may be performed by using only the first image or based on the signal image after background subtraction. The software reads the spatial code out of the image, for instance using a built-in function of a conventional image reader such as found in the Labview™ software (National Instruments Inc.), and returns a number, which is then matched to the database to get the identity of the tag. Prior to the decoding, a pre-validation step (described hereafter) may occur.

If the code identity exists in the database, the validation process starts. This procedure may, in an exemplary embodiment be divided into a number of levels, for instance 3 levels: the first level deals with the images acquired by the camera, while the last two levels may be based on the spectrum profiles recorded by the spectrometer. Each step is more restrictive than the previous one, thus increasing security.
Level 1
   the differential image is decomposed into 3 colour channels, i.e. red, green, and blue
      the colour ratios match the database information =>PASS
      the colour ratios do not match the database information =>FAILS
Level 2
   peak wavelength recognition from the differential spectrum profile
      peak positions match the database information =>PASS
      peak positions do not match the database information =>FAILS
Level 3
   calculation of the intensity ratios between several specific peaks
      the ratios do not match the database information =>FAILS

In order to be authenticated, in the above example a tag needs to pass these 3 levels of validation process carried out by the reader software.

Level 1 of the validation process carried out by the reader software enables the system to determine whether the luminescent material is a specific selected luminescent material and thus authentic, or not. If it would be any standard luminescent material, it would shine over a broad spectrum, while specific selected luminescent particles may only generate defined peaks in specific bands, for instance in a green band (around 550 nm) and in a red band (around 670 nm) of the visible spectrum, as illustrated in Erreur ! Source du renvoi introuvable. The specific selected material has a readable spectrum signature that differentiates it from other luminescent materials that possess another spectrum signature. In this example, the intensity in the green channel is greater than in the red channel, while the blue intensity is close to zero. This first level of validation confers an enhanced security to the method without slowing down the process. Indeed, it may start before completing the acquisition of the spectral data by the spectral unit 112 as it relies only on the information gathered by the imaging unit 111. Moreover, in the case if the tag contains different types of luminescent particles, this first level of validation enables to quickly analyse the spectral components of each dot in a single synchronous acquisition. This also enables to locate the structures containing different particles and define their position for the spectral unit to acquire their spectra (with a galvo-mirror scanner if necessary).

During the level 2 of the validation process carried out by the reader software, the precise positions of the peak intensities along the wavelength axis are detected, which confers a high accuracy to the authentication process.

During level 3 of the validation process carried out by the reader software, the ratios between different peak intensities are computed, such as G1/R1 and G1/G2 in the particular example shown in FIG. 8. These values allow to accurately characterising the spectrum signature of the luminescent material used in the tag. The computation of the different ratios between the peak values may also be performed by other means of calculation, such as a correlation with a spectrum profile contained into the database. The correlation is a very sensitive way of determining whether two curves present similar shapes or not.

Each level of the authentication process is more restrictive than the previous level. This authenticating process in 3 levels enables to discard a non-genuine tag very rapidly without involving time-consuming calculations. Indeed, the first level can be even performed while still acquiring the spectral data and the second level is performed much more rapidly than the third level.

In a variant, it is possible to add another level to the validation process by measuring the fluorescence lifetime of the particles. This parameter enables to further differentiate specific selected luminescent particles from other luminescent materials. The fluorescence lifetime corresponds to the average duration during which luminescent molecules remain excited before releasing their energy by emitting light. In order to measure such delays, an additional photodiode may be placed into the reader.

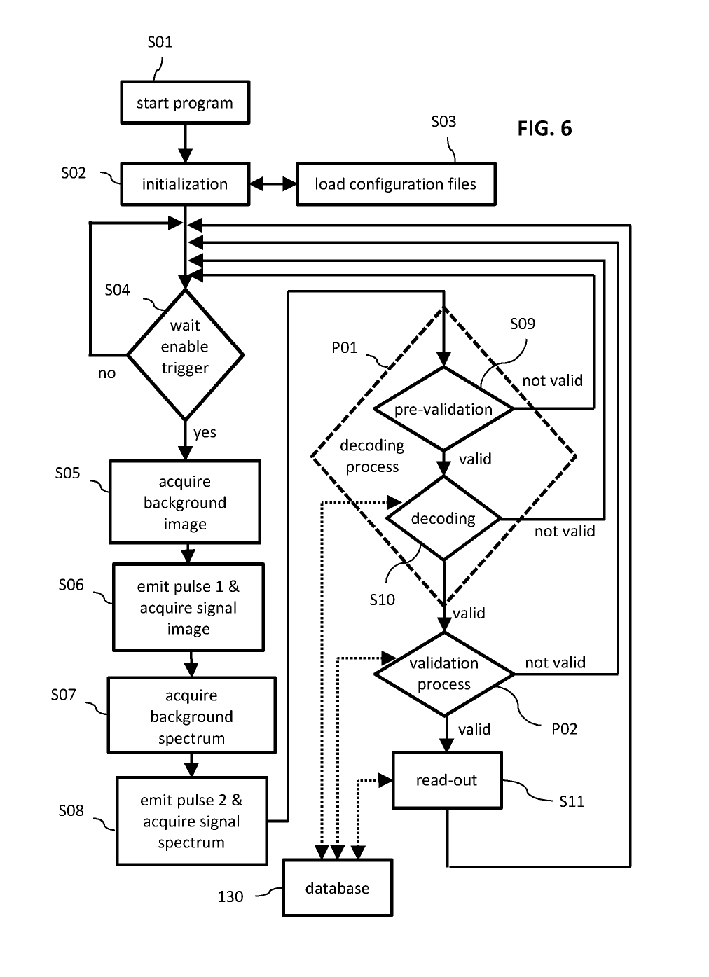

FIG. 6 shows a flow-chart representing the steps (S) and processes (P) of an embodiment of a method to identify and authenticate a tag 101 as shown in FIG. 1 that can be performed by various units of the system 100 described above. Once the program starts S01, the configuration files are loaded S03 and the program initialises SO2 the reading process by the reading module 110. This process may start upon triggering SO4. Upon triggering, the timing control unit 115 controls the sequence of the reading process and in turn triggers light pulses from the lighting unit 114 and synchronizes the acquisition of the imaging unit 111 and spectral unit 112. In step S05, the imaging unit 111 acquires a background image followed in step S06 by the acquisition of a signal image synchronised onto the emission of a first light pulse by the lighting unit 114. Next, the spectral unit 112 acquires a background spectrum S07 and acquires a signal spectrum S08 synchronised onto the emission of a second light pulse by the lighting unit 114.

The information recorded by the reading module units is delivered to the processing module 120. Then, the decoding process P01 takes place, meaning that the decoding unit 121 first identifies the tag by retrieving the tag serial number from the database 130. This decoding is based on the images of the spatial pattern recorded by the imaging unit 111.

Prior to the proper decoding step S10, the decoding unit 121 may perform a pre-validation step S09 in order to ensure that the tag contains luminescent particles excitable by the lighting unit 114. This pre-validation step S09, which could be optional, consists in subtracting the background image to the signal image. If the resulting image reveals the optically activated spatial pattern, the pre-validation S09 is successful and the decoding S10 starts.

After a successful identification of the tag by the decoding process, the validation process P02 takes place. The validation unit 122 validates the tag by comparing the spectrum acquired by the spectral unit 112, to predetermined spectra of the “authentic” tags stored in the database 130. The validation unit may in addition use the data acquired by the imaging unit 111. In this case it proceeds to a validation process in two distinctive steps: the analysis of the image colours followed by the analysis of the spectrum as detailed above in the paragraph describing the validation 122 unit.

Finally, the read-out step S11, performed by the read-out unit 124, discloses information about the tag once authenticated.

In another embodiment, process P01 is performed in parallel to steps S07 and S08 in order to speed up the full procedure. Only the use of sequential individual excitation light pulses for the imaging and the spectral unit allows implementing this parallel workflow. Moreover, the first level of the validation process P02 can also be performed while still acquiring the spectral data (S07 and S08). Thus, the use of the information recorded by the imaging unit for the validation process as well allows a faster rejection of non-genuine tags as the steps S07 and S08 do not need to be completed prior the level 1 of the validation process P02.

As mentioned above, a further validation step may be added to further increase the security level of the authentication. This step measures the fluorescence lifetime of the particles contained into the tag either by the use of the information recorded by the imaging unit 111, possibly by the use of an additional dedicated sensor, such as a photodiode. This step may use a different timing scheme with a time modulation of the excitation light intensity. Again, the measured values are compared to the corresponding information recorded into the database.

A person skilled in the art will appreciate that the system design described here may vary but still remain in the scope of the current invention. For example, we propose to use independent optical paths for each unit of the reading module 110. It is also possible to share some optical components for different units, such as lenses for the lighting unit 114 and the spectral units 112. In that case, the separation between the two paths could be performed by the use a dichroic mirror. Moreover, in special cases where the light emitted by the tag would be weak or for long-distance detection, dedicated schemes for low signal amplification may be implemented.

1-33. (canceled)

34. A system for identifying and authenticating a tag applied to an object, wherein the tag is defined by at least one luminescent spatial pattern and one spectral signature of luminescent particles contained in said tag and defining said spatial pattern, the system comprising:
a reading module to acquire the tag information, said reading module comprising:
a lighting unit comprising a light source operated in a pulse-mode, said light source being adapted to illuminate the tag with excitation light so as to excite the particles of the tag, thus resulting in the emission of the luminescent spatial pattern by the tag,
an imaging unit adapted to record an image of said spatial pattern,
a spectral unit adapted to record the spectrum of said spectral signature,
a timing control unit adapted to synchronize the actions of the other units of the reading module,
a processing module both in communication with the reading module and with a database containing the spatial patterns and spectral signatures of predetermined tags, said processing module comprising:
a decoding unit adapted to decode the image recorded by the imaging unit, provide a serial number corresponding to said image and compare said serial number with the corresponding serial numbers of the predetermined tags so as to identify the tag, and
a validation unit adapted to compare the spectrum recorded by the spectral unit with the spectra of the predetermined tags so as to authenticate the tag,
wherein the imaging unit and the spectral unit record the respective image and spectrum in a sequential manner, their acquisition being synchronized with different excitation light pulses.

35. The system according to claim 34, wherein a first and a second excitation light pulses are used.

36. The system according to claim 35, wherein the acquisition of the imaging unit is synchronized with the first excitation light pulse and the acquisition of the spectral unit is synchronized with the second pulse.

37. The system according to claim 34, wherein the imaging unit records a signal image and a background image and the spectral unit records a signal spectrum and background spectrum.

38. The system according to claim 37, wherein the decoding unit performs the identification of the tag using the image resulting from the subtraction of the background image from the signal image and the spectral unit performs the validation of the tag using the spectrum resulting from the subtraction of the background spectrum from the signal spectrum.

39. The system according to claim 34, further comprising a global positioning unit and a localization unit.

40. A tag applied to an object, comprising a plurality of dots, each dot comprising one or more luminescent materials, the plurality of dots defining a luminescent spatial pattern and a spectral signature, wherein one or more of said plurality of dots comprise at least one luminescent material different from at least one luminescent material in one or more of other of said plurality of dots, the different luminescent materials emitting different spectra, whereby the tag defines a code comprising a plurality of values greater than binary values.

41. A method for identifying and authenticating a tag applied to an object, wherein the tag is defined by at least one luminescent spatial pattern and one spectral signature of luminescent particles contained in said tag and defining said spatial pattern, comprising the steps of :
illuminating the tag with excitation light emitted by a light source operated in a pulse-mode so as to excite the luminescent particles of the tag, thus resulting in the emission of the luminescent spatial pattern by the tag,
recording with an imaging unit of an image of said spatial pattern,
recording with a spectral unit of a spectrum of said spectral signature,
decoding with a decoding unit of said image so as to identify the tag,
validating with a validation unit of said spectrum so as to authenticate the tag,
wherein the imaging unit and the spectral unit record their respective data in a sequential manner, their acquisition being synchronized with different excitation light pulses.

42. The method according to claim 41, wherein a first and a second excitation light pulses are used.

43. The method according to claim 42, wherein the acquisition of the imaging unit is synchronized with the first excitation light pulse and the acquisition of the spectral unit is synchronized with the second excitation light pulse.

44. The method according to claim 41, wherein the imaging unit records a signal image and a background image and the spectral unit records a signal spectrum and background spectrum.

45. The method according to claim 44, wherein the decoding unit performs the identification of the tag using the image resulting from the subtraction of the background image from the signal image and the spectral unit performs the validation of the tag using the spectrum resulting from the subtraction of the background spectrum from the signal spectrum.

46. The method according to claim 41, further comprising a step of determining the exact position of the tag.

47. A method for identifying and authenticating a tag applied to an object, wherein the tag is defined by at least one luminescent spatial pattern and one spectral signature of luminescent particles contained in said tag and defining said spatial pattern, comprising the steps of:
illuminating the tag with excitation light emitted by a light source operated in a pulse-mode so as to excite the luminescent particles of the tag, thus resulting in the emission of the luminescent spatial pattern by the tag,
recording with an imaging unit of a signal image and a background image of said spatial pattern,
subtracting the background image from the signal image so as to determine an image of said spatial pattern,
recording with a spectral unit of a signal spectrum and a background spectrum, of said spectral signature,
subtracting the background spectrum from the signal spectrum so as to determine a spectrum of said spectral signature,
decoding with a decoding unit of said images, so as to identify the tag, and
validating with a validation unit of said image and the spectrum, by
decomposing said image into different colour components and comparing the intensity ratios between said colour components with the information stored in the database, and
comparing said spectrum to the spectra stored in the database.

48. The method according to claim 47, wherein the decoding unit performs a pre-validation step consisting in checking the presence of the spatial pattern on the image resulting from the subtraction of the background image from the signal image.

49. The method according to claim 47, wherein the validation unit performs a first validation level using the information recorded by the imaging unit by decomposing the image of the tag into three colour components and analysing their ratios.

50. The method according to claim 49, wherein the validation unit performs a second and third validation levels using the information recorded by the spectral unit by analysing the peak intensities at certain wavelengths and the ratios between these values.

51. The method according to claim 47, wherein the validation unit performs a further step of calculating the fluorescence lifetime of the particles.

52. A system for identifying and authenticating a tag applied to an object, wherein the tag is defined by at least one luminescent spatial pattern and one spectral signature of optically active nanoparticles contained in said tag and defining said spatial pattern, the system comprising:
a reading module to acquire the tag information, said reading module comprising:
a lighting unit comprising a light source driven in a pulse-mode, said light source being adapted to illuminate the tag with infrared excitation light so as to excite the nanoparticles of the tag, thus resulting in the emission of the luminescent spatial pattern by the tag,
an imaging unit adapted to record an image of said spatial pattern,
a spectral unit adapted to record the spectrum of said spectral signature,
a timing control unit adapted to synchronize the actions of the other units of the reading module,
a processing module both in communication with the reading module and with a database containing the spatial patterns and spectral signatures of predetermined tags, said processing module comprising:
a decoding unit adapted to decode the image recorded by the imaging unit, provide a serial number corresponding to said image and compare said serial number with the corresponding serial numbers of the predetermined tags so as to identify the tag,
a validation unit adapted to compare the spectrum recorded by the spectral unit with the spectra of the predetermined tags so as to authenticate the tag, and
a read-out unit to disclose information about the tag once authenticated,
wherein the imaging unit and the spectral unit record their respective data in a sequential manner, their acquisition being synchronized with different excitation light pulses.

53. The system according to claim 52, wherein a first and a second excitation light pulses are used.

54. The system according to claim 52, wherein the acquisition of the imaging unit is synchronized with the first excitation light pulse and the acquisition of the spectral unit is synchronized with the second pulse.

55. The system according to claim 52, wherein the imaging unit records a signal image and a background image and the spectral unit records a signal spectrum and background spectrum.

56. The system according to claim 55, wherein the decoding unit performs the identification of the tag using the image resulting from the subtraction of the background image to the signal image and the spectral unit performs the validation of the tag using the spectrum resulting from the subtraction of the background spectrum from the signal spectrum.

57. The system according to claim 52, further comprising a global positioning unit and a localization unit.

58. A method for identifying and authenticating a tag applied to an object, wherein the tag is defined by at least one luminescent spatial pattern and the one spectral signature of optically active nanoparticles contained in said tag and defining said spatial pattern, comprising the steps of :
illuminating the tag with infrared excitation light emitted by a light source driven in a pulse-mode so as to excite the nanoparticles of the tag, thus resulting in the emission of the luminescent spatial pattern by the tag,
recording with an imaging unit of an image of said spatial pattern,
recording with a spectral unit of a spectrum of said spectral signature,
decoding with a decoding unit of said image so as to identify the tag,
validating with a validation unit of said spectrum so as to authenticate the tag,
wherein the imaging unit and the spectral unit record their respective data in a sequential manner, their acquisition being synchronized with different excitation light pulses.

59. The method according to claim 58, wherein a first and a second excitation light pulses are used.

60. The method according to claim 58, wherein the acquisition of the imaging unit is synchronized with the first excitation light pulse and the acquisition of the spectral unit is synchronized with the second excitation light pulse.

61. The method according to claim 58, wherein the imaging unit records a signal image and a background image and the spectral unit records a signal spectrum and background spectrum.

62. The method according to claim 61, wherein the decoding unit performs the identification of the tag using the image resulting from the subtraction of the background image from the signal image and the spectral unit performs the validation of the tag using the spectrum resulting from the subtraction of the background spectrum from the signal spectrum.

63. The method according to claim 58, further comprising a step of determining the exact position of the tag.

64. A method for identifying and authenticating a tag applied to an object, wherein the tag is defined by at least one luminescent spatial pattern and the one spectral signature of optically active nanoparticles contained in said tag and defining said spatial pattern, comprising the steps of:
illuminating the tag with an infrared excitation light emitted by a light source driven in a pulse-mode so as to excite the nanoparticles of the tag, thus resulting in the emission of the luminescent spatial pattern by the tag,
recording with an imaging unit of a signal image and a background image of said spatial pattern,
subtracting the background image to the signal image so as to determine an image of said spatial pattern,
recording with a spectral unit of a signal spectrum and a background spectrum, of said spectral signature,
subtracting the background spectrum from the signal spectrum so as to determine a spectrum of said spectral signature,
decoding with a decoding unit of said images, so as to identify the tag, and
validating with a validation unit of said image and the spectrum, by
decomposing said image into different colour components and comparing the intensity ratios between said colour components with the information stored in the database, and
comparing said spectrum to the spectra stored in the database.

65. The method according to claim 64, wherein the decoding unit performs a pre-validation step consisting in checking the presence of the spatial pattern on the image resulting from the subtraction of the background image from the signal image.

66. The method according to claim 64, wherein the validation unit performs a further step of calculating the fluorescence lifetime of the nanoparticles.
